(19) United States
(12) Patent Application Publication
(10) Pub. No.: US 2025/0077380 A1
(43) Pub. Date: Mar. 6, 2025

(54) MODEL DRIVEN AGENTS FOR SYNTHETIC MONITORING

(71) Applicant: Cisco Technology, Inc., San Jose, CA (US)

(72) Inventors: Mahesh Shivajirao KANOTE, BENGALURU (IN); Manoj Kumar GOYAL, BENGALURU (IN)

(21) Appl. No.: 18/242,647

(22) Filed: Sep. 6, 2023

(51) Int. Cl. G06F 11/34

(52) U.S. Cl. CPC G06F 11/3409

(57) ABSTRACT

According to embodiments of the disclosure, an example method herein may comprise: receiving, by a device, a model defining a configuration of synthetic monitoring operations to be performed by the synthetic agent; converting, by the device, the model into code to be utilized by the synthetic agent to perform the synthetic monitoring operations; transforming, by the device, results from a performance of the synthetic monitoring operations into transformed results in a common data format; and providing, by the device, the transformed results to a datastore.

### TECHNICAL FIELD

The present disclosure relates generally to computer systems, and, more particularly, to model driven agents for synthetic monitoring.

### BACKGROUND

Synthetic monitoring is often used today to actively test the performance of online applications. For instance, synthetic monitoring is useful for measuring application performance metrics such as uptime, response time of critical pages, application programming interfaces (APIs), etc. during business transactions by using algorithms to observe the behavior of the application while simulating future user interactions.

Unfortunately, existing synthetic monitoring agents are highly complex in both their designs and implementations. As a result, they have limited language support and rely on highly specific collectors that collect very specific unique data types in predefined formats, and they lack the capability for generic and standardized automated instrumentation. Users of these agents are thus required to implement collection logic based on the data type, which can be time-consuming and complex. Additionally, the scalability of these agents is insufficient for use cases such as synthetic monitoring, industrial automation, end user digital experience monitoring, code profiling, and application security. This necessitates users to invest significant time and effort in running and managing these agents. Increasingly, users do not have the time and/or the expertise for this type of investment and instead largely elect to ‘fly blind’ with respect to issue identification and debugging. Neglecting performance monitoring in this manner typically leads to increased time to issue resolution, degraded product and network performance, and increased wasting of computational resources.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an environment for generating model driven agents for synthetic monitoring;

FIG. 5 illustrates an example of a hybrid cloud environment including model-driven agents for synthetic monitoring; and

FIG. 6 illustrates an example simplified procedure for utilizing model driven agents for synthetic monitoring.

### DESCRIPTION OF EXAMPLE EMBODIMENTS

### Overview

According to one or more embodiments of the disclosure, a method is introduced herein that allows for the creation and use of model driven agents for synthetic monitoring. The method may include receiving, by a device, a model defining a configuration of synthetic monitoring operations to be performed by the synthetic agent; converting, by the device, the model into code to be utilized by the synthetic agent to perform the synthetic monitoring operations; transforming, by the device, results from a performance of the synthetic monitoring operations into transformed results in a common data format; and providing, by the device, the transformed results to a datastore.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

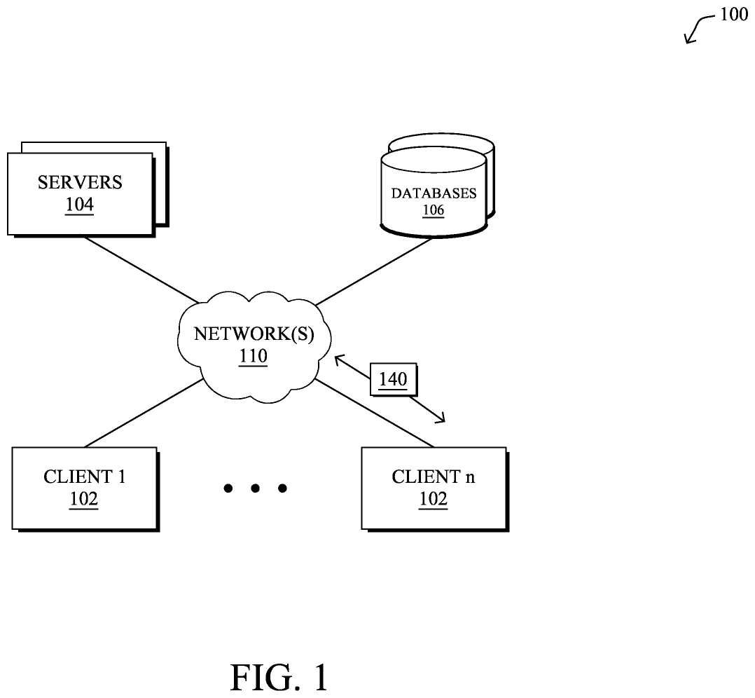

FIG. 1 is a schematic block diagram of an example simplified computing system 100 illustratively comprising any number of the client devices 102 (e.g., a first through nth client device), one or more of servers 104, and one or more of databases 106, where the devices may be in communication with one another via any number of networks (e.g., networks 110). The one or more networks (e.g., networks 110) may include, as would be appreciated, any number of specialized networking devices such as routers, switches, access points, etc., interconnected via wired and/or wireless connections. For example, devices 102-104 and/or the intermediary devices in network(s) (e.g., networks 110) may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) (e.g., networks 110).

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in simplified computing system 100, and that the view shown herein is for simplicity. Also, those skilled in the art will further understand that while the network is shown in a certain orientation, the simplified computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

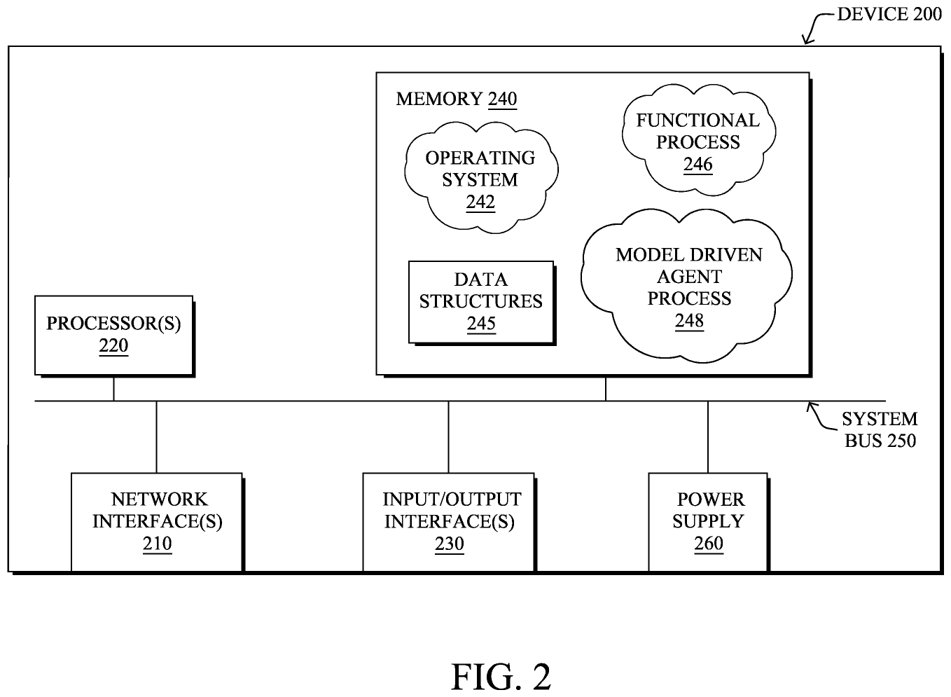

FIG. 2 is a schematic block diagram of an example node/device 200 that may be used with one or more embodiments described herein, e.g., as any of the devices 102-106 shown in FIG. 1 above. Device 200 may comprise one or more network interfaces (e.g., network interfaces 210) (e.g., wired, wireless, etc.), at least one processor (e.g., processor 220), and a memory 240 interconnected by a system bus 250, as well as a power supply 260 (e.g., battery, plug-in, etc.).

The network interface(s) (e.g., network interfaces 210) contain the mechanical, electrical, and signaling circuitry for communicating data over links coupled to the network(s) (e.g., networks 110). The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more of functional processes 246, and on certain devices, an illustrative “model driven agent” process (e.g., model driven agent process 248), as described herein. Notably, functional processes 246, when executed by processor(s) (e.g., processor 220), cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### Observability Intelligence Platform

Distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

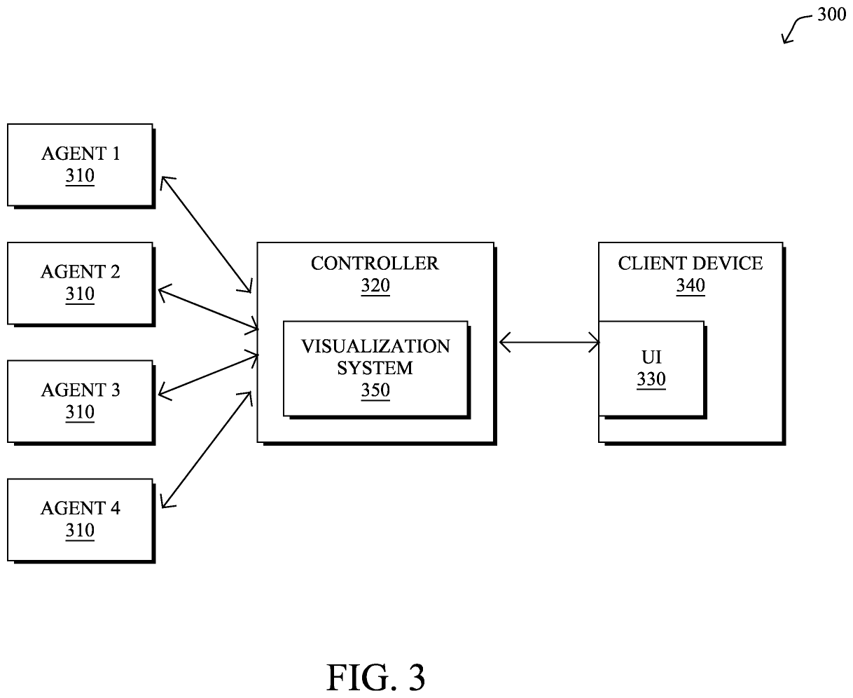

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more of agents 310 and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) (e.g., controller 320) as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (e.g., interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance (e.g., controller 320) may be hosted remotely by a provider of the observability intelligence platform 300. In an illustrative on-premises (On-Prem) implementation, a controller instance (e.g., controller 320) may be installed locally and self-administered.

Controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Model Driven Agents for Synthetic Monitoring

As noted above, one approach incorporated to observability intelligence collection involves synthetic monitoring operations. Synthetic monitoring operations may involve actively testing a target website, application, resource, etc. via a synthetic monitoring agent. Typically, a user experience consists of multiple moving pieces, and yet the ideal experience requires that the end-user enjoys a seamless transaction uninterrupted by broken links, slow page load times, outages, or issues with third-party web applications. Synthetic monitoring agents may be used to simulate the average customer's experience to discover the root cause of potential issues that may negatively impact actual users.

For example, synthetic testing via synthetic monitoring agents allows a user to setup specific scenarios by using scripted transactions executable by the synthetic monitoring agent to identify issues that could potentially affect end users of the system under test. This kind of active performance monitoring may be useful for rapidly alerting administrators to problems across a wide range of different uses. For example, synthetic monitoring may be utilized for measuring uptime, performance, and response time of critical pages during business transactions by using algorithms to observe application behavior while practicing future user interactions.

Although synthetic monitoring is helpful in assessing system performance, it's not without its own weaknesses. For instance, existing synthetic monitoring agents are made up of highly bespoke logic that produces specifically unique results. As a result, they have limited language support and rely on highly specific collectors. In addition, they lack the capability for automated instrumentation. Ultimately, users of these agents are required to implement collection logic based on the data type, which can be time-consuming, complex, and require a degree of technical knowledge. Additionally, these agents are not practically scalable since they are so job, environment, and/or format/language specific. For instance, existing agents are so personalized that they are not able to comply with common data format (e.g., OpenTelemetry (OTEL) data format) monitoring instrumentation. Further, existing synthetic agents are not able to be adapted into any sort of centralized agent management instrumentation given their disparities.

Beyond these functional limitations, the present model for synthetic monitoring agents imposes a great deal of practical limitations to development, deployment, and management of the agents. For example, developing a synthetic monitoring agent presently requires a great deal of in-depth technical expertise, effort, and manual intervention to engineer the bespoke synthetic agent with precisely engineered collection logic in a particular scripting language for use in a particular runtime environment for collecting and storing a particular type of data. In addition, updates to a synthetic monitoring operation and/or changes to a system undertest often necessitate a complete manual redesign of the scripting for a synthetic monitoring agent.

As a result, many users simply do not have the resources (e.g., time, expertise, knowledge, personnel, etc.) to be able to deploy synthetic monitoring agents to proactively monitor performance and availability nor is there any existing mechanism by which to manage existing agents in a centralized manner. The result is a less prolific and lower-quality monitoring which translates directly to a degradation in the performance of applications/websites/etc., a degradation in the performance of underlying computing devices, a degradation in the performance of the underlying computing network, and/or increased presence and duration of vulnerabilities.

In contrast, the techniques herein introduce mechanisms for generating, deploying, and/or utilizing model driven agents for synthetic monitoring. These techniques facilitate deployment of low-code agents with automated instrumentation that are highly scalable, polyglot, centrally manageable, and/or can be deployed with zero-touch provisioning. These techniques facilitate users in proactively monitoring performance and availability of their systems without engineering overheads and manual intervention. Therefore, these techniques improve applications/websites/etc. performance, underlying computing device performance, underlying computing network performance, and/or attack surface identification and mitigation.

Illustratively, the techniques described herein may be performed by hardware, software, and/or firmware, such as in accordance with model driven agent process 248, which may include computer executable instructions executed by the processor 220 (or independent processor of network interfaces 210) to perform functions relating to the techniques described herein.

Specifically, according to various embodiments, a method may include receiving, by a device, a model defining a configuration of synthetic monitoring operations to be performed by the synthetic agent; converting, by the device, the model into code to be utilized by the synthetic agent to perform the synthetic monitoring operations; transforming, by the device, results from a performance of the synthetic monitoring operations into transformed results in a common data format; and providing, by the device, the transformed results to a datastore.

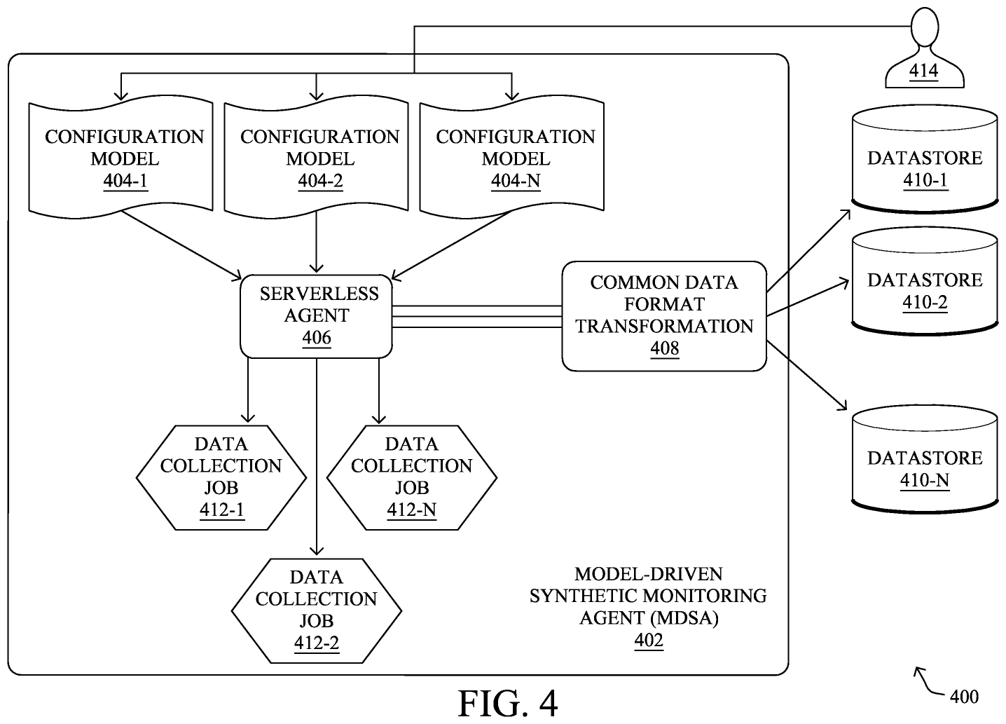

Operationally and according to various embodiments, FIG. 4 illustrates an example of an environment 400 for generating model-driven agents for synthetic monitoring. Environment 400 may include a mechanism by which configurations may be pushed as a model to a serverless agent 406 to configure a model-driven synthetic monitoring agent (MDSA 402). This allows a user 414 to proactively monitor user experience, performance, and availability of their systems with automated instrumentation of low-code synthetic agents that are highly scalable, polyglot, and zero-touched provisioned, all without incurring excessive engineering overheads and requiring manual intervention.

In environment 400, MDSA 402 may instrument and measure a user experience or other performance metrics based on code generated from a generic model specification (e.g., a code agnostic model, a model that does not include collection logic in a particular scripting language, etc.) as configured by user 414. For example, user 414 may wish to instrument an MDSA with one or more of data collection jobs 412 (e.g., 412-1 . . . 412-N) tailored to a specific job in a specific runtime environment. Rather than tediously writing a script or code snippet that simulates user interactions with an application or website in a particular scripting language (e.g., JavaScript, Python, Java, GO, Ruby, C#, etc.) depending on the tool or framework being used, user 414 may simply configure a generic model specification.

For instance, user 414 may configure one or more portions of a segmented model specification. That is, the model specification may be segmented into various (e.g., three) sections that user 414 may modify on an individual basis as the need arises. For example, the model specification may include a job config portion, a run config portion, and/or a credential config portion, that are each individually configurable by user 414.

A job configuration portion of the model specification may be configured by user 414 to specify the job to be performed by MDSA 402. For example, user 414 may configure, within the job configuration portion of the model specification, a user journey such as a series of user behaviors that an MDSA 402 is to mimic in testing a target system system. As an example, user 414 may specify a job such as logging into an ecommerce website, browsing product offerings, adding an offering to a virtual shopping cart, and completing the checkout process for the offering. In some instances, user 414 may configure the job configuration portion of the model specification by providing pre-recorded user journeys in the form of scripts or code-snippets which may be offered in any scripting language regardless of the intended target language for the data collection jobs 412. In addition, user 414 may specify private repositories for the job. In various embodiments, the job configuration portion of the model specification may include the following:

```
{
  ″description″: ″The Job Description Optional Parameter″,
  ″metadata″:
  {
  ″webUrl″: ″The Website URL to be monitored″,
  ″userJourneyScript″:
  {
  ″templateType″: ″The user journey template type out of box
available with agent″,
  ″customScript″: ″The user journey custom script from customer″,
  ″repoURL″: ″Location of custom code snippets″
  },
  ″runConfigId″: ″The run config to apply during execution of Job.
Default runtime configs applied when not provided.″
  }
}.
```

A run configuration portion of the model specification may be configured by user 414 to specify how the job is to be performed by MDSA 402. For example, the run configuration portion of the model specification may be configured by user 414 to specify information related to the runtime environment of the job to be performed by MDSA 402. In various embodiments, user 414 may configure, within the run configuration portion of the model specification, a location, network bandwidth, upload speed, download speed, browser type, frequency of execution of collection jobs, schedule of collection jobs, format of measurement, etc. for testing a targeted system by MDSA 402. As a part of runtime configuration, user 414 can specify multiple schedules for data collection jobs 412 at regular intervals. Further, user 414 may specify one or more specific scripting languages of the runtime environment and/or one or more specific scripting languages in which the logic of a data collection job should be scripted. In various embodiments, the run configuration portion of the model specification may include the following:

```
}
  ″scheduleMode″: ″One of NONE, ROUND_ROBIN_BROWSER,
ROUND_ROBIN_LOCATIONS, ROUND_ROBHIN_BOTH″,
  ″timeoutSeconds″: ″Timeout configuration to exit the job after
given timeout to avoid resource utilization″,
  ″browserCodes″: ″The supported browsers for Website
performance and availability monitoring″,
  ″locationCodes″: ″The MDSA runtime locations″,
  ″outputFormat″: ″OTEL/HAR″,
  ″subSchedules″:
  {
  ″rate″:
  {
  ″value″: ″The frequency of execution″,
  ″unit″: ″One of MINUTES, HOURS, DAYS″
  },
  ″daysOfWeek″: [
  ″MON″,
  ″TUES″,
  ″WED″
  ],
  ″timeRange″:
  {
  ″startHour″: ″″,
  ″startMinute″: ″″
  ″endHour″: ″″
  ″endMinute″: ″″
  },
  'timezone″: ″The time zone for which execution is created″,
  ″networkProfile″:
  {
  ″type″: ″The type of network profiles supported″,
  ″downloadKbps″: 0,
  ″uploadKbps″: 0,
  ″addedLatency″: 0,
  ″packetLostPercentage″: 0
  },
  ″capture VisualMetrics″: true
  }
}.
```

A credential configuration portion of the model specification may be configured by user 414 to specify credentials and/or secrets that may be involved in and/or need to be shared as part of the user journey being performed by MDSA 402. For instance, enterprises and financial institutions provision different types of mechanisms to authenticate and/or authorize users as per their security compliance policies. Some examples include Open Authorization (OAuth), Identity Provider (IDP), Basic Authentication (Basic Auths), Security Assertion Markup Language (SAML), and Multi-Factor Authentication (MFA). Therefore, the corresponding credentials for the authentication and/or authorization mechanisms mechanisms present as part of a user journey must be provided to the MDSA in order to successfully complete its testing. MDSA 402 will support all of the described authentication and/or authorization methods and others. User 414 may configure the run configuration portion of the model specification to identify requisite credentials/secrets in encrypted form and/or the location of private secrete vaults from which the credentials/secrets may be fetched for use by MDSA 402. In various embodiments, the credential configuration portion of the model specification may include the following:

```
{
  ″key″: ″Credential key name″,
  ″value″: ″Credential Value″
}.
```

MDSA 402 may maintain and/or have access to a library of pre-recorded user journey automated test templates. In some instances, these automated test templates may be selenium templates. These templates can be written in various programming languages, such as JavaScript, Python, Java, PHP, GO, Ruby, C#, etc. that may be used for automating web browsers, testing web applications, etc. For instance, the automated test templates may contain the necessary code to initialize a web browser, navigate to a specific webpage, interact with elements on the page (such as clicking buttons or entering text in input fields), and perform various validation checks to verify the behavior of the application. These automated test templates may be customizable such as by adding more test steps, assertions, and logic to create comprehensive and reusable test scripts tailored to a user's specific web application's testing needs.

In various embodiments, user 414 may be provided one or more of these automated test templates to leverage and/or customize as per their need. For example, the user 414 may communicate their requirements for data collection jobs 412 to the MDSA 402. These requirements may be presented via the model specification and/or other forms or questionnaires. MDSA 402 may analyze the requirements specified by user 414 and/or compare those requirements to the functionality of each automated test templates within its library of pre-recorded automated test templates. Based on this comparison, MDSA 402 may identify one or more of its automated test templates which match the user specified requirements. MDSA 402 may then communicate the match, information about the matching automated test template, and/or the matching automated test template itself to user 414. User 414 may then customize (e.g., add, delete, modify, etc.) the matching automated test template to further tailor it to their specific targeted collection jobs.

In environment 400, the interaction with user 414 may result in the submission of one or more of configuration models 404 (e.g., 404-1 . . . 404-N) to serverless agent 406. Configuration models 404 may include the model specification as configured by user 414, automated test templates which may have been customized by user 414, and/or job configuration models (e.g., configuration models 404) derived therefrom. Serverless agent 406 may then utilize these configuration models 404 to generate corresponding data collection jobs in a zero-touch provisioning manner. Running MDSA 402 as a serverless-service may facilitate the pushing of runtime configuration as a model since the serverless agent 406 may create data collection jobs 412 based on configuration specifications contained in configuration models 404.

The configuration models 404 may include user-specified parameters for collection and inflight data processing logic targets for corresponding data collection jobs. In that way, configuration models 404 provide a plug-and-play mechanism whereby user 414 need not change agent code for each and every use case. Being a serverless service, MDSA 402 can spin hundreds, if not thousands, of data collection jobs 412 in parallel in the context of multi-tenancy in complete isolation.

For example, a first configuration model 404-1 may specify a first configuration for provisioning a first data collection job 412-1 in a first scripting language (e.g., Python). A second configuration model 404-2 may specify a second configuration for provisioning a second data collection job 412-2 (which may or may not be the same user journey as the first configuration for the first data collection job 412-1) in a second scripting language (e.g., Java). A third configuration model 404-N may specify a third configuration for provisioning a third data collection job 412-N(which may or may not be the same user journey as the first configuration for the first data collection job 412-1 and/or the second configuration for the second data collection job 412-2) in a second scripting language (e.g., JavaScript), which could allow a user to compare the performances of synthetic automation scripts.

Serverless agent 406 may perform an automated creation of one or more of the data collection jobs 412 in parallel based on their corresponding configuration model. That is, serverless agent 406 may automatically convert a configuration model into corresponding data collection job code to be utilized by the MDSA 402 to perform the synthetic monitoring operations including emulating user activity and/or collecting performance metrics resulting therefrom.

Serverless agent 406 may create each of the data collection jobs 412 in the scripting language specified in its corresponding configuration model. For example, the first data collection job 412-1 may be created with job execution logic, data collection logic, and/or inflight data processing logic in the first scripting language (e.g., Python), the second data collection job 412-2 may be created with job execution logic, data collection logic, and/or inflight data processing logic in the second scripting language (e.g., Java), and/or the third data collection job 4125-N may be created with job execution logic, data collection logic, and/or inflight data processing logic in the third scripting language (e.g., JavaScript).

Unlike existing synthetic monitoring agents, the MDSA 402 and/or the data collection jobs 412 may be configured by serverless agent 406 (e.g., per a corresponding configuration model) to collect performance metrics from the execution of the data collection jobs 412 by MDSA 402 in a common data format (e.g., OTEL) and/or to transform any performance metric collected from the execution into the common data format. In some instances, this may include the serverless agent 406 performing a common data format transformation 408, whereby performance metrics collected in relation to the job execution by the MDSA are transformed from their native format to the common data format for ingestion. That is, MDSA 402 may be configured to accept and/or generate data points in a common data format.

This common data format is unlike the highly tailored and unique data format associated with the data collected and/or generated by existing synthetic monitoring agents. With existing synthetic monitoring agents, whatever application or website the existing synthetic monitoring agent is monitoring, it is ultimately going to affect what its inputs and/or output look like. In contrast, serverless agent 406 transforms MDSA 402 and/or data collection jobs 412 such that its outputs are converted it into a common data format (e.g., OTEL) that is more universally comparable and compatible with the diverse observability monitoring utilities currently available.

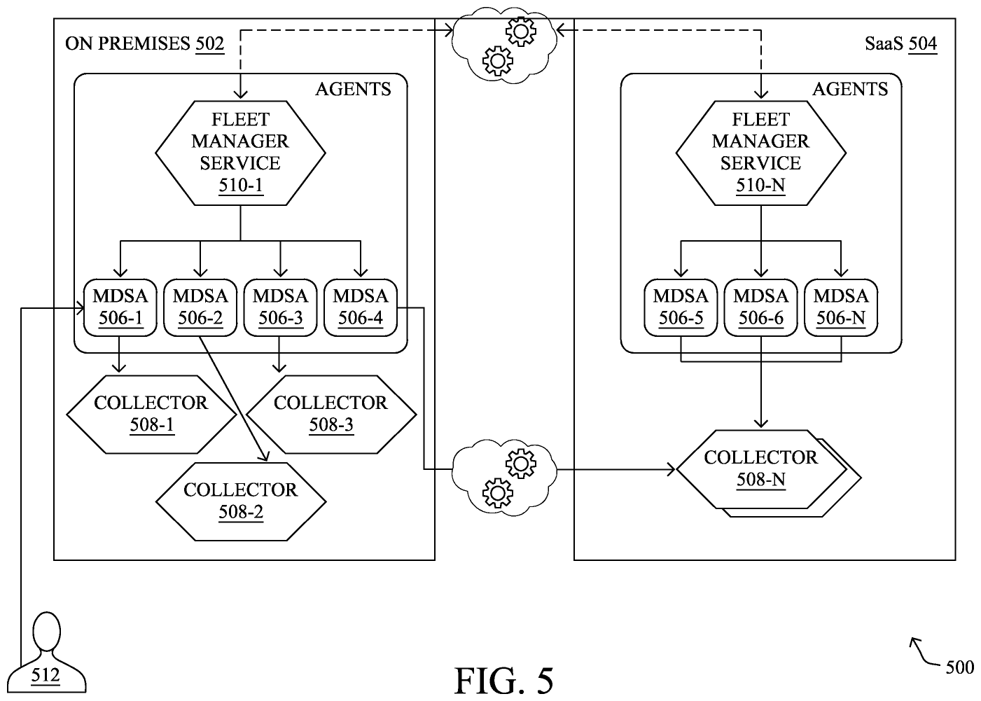

Serverless agent 406 may ingest performance metric data collected from the data collection jobs 412 in the common data format and/or perform the common data format transformation 408 to transform results from a performance of the synthetic monitoring operations into transformed results in the common data format. Then, the performance metric data in the common data format may be ingested into datastores 410. The datastores 410 into which performance metric data for a particular job is ingested may be those datastore specified by user 414 in, for example, the model specification configured by user 414, automated test templates which may have been customized by user 414, and/or configuration models 404 for that job. For example, the performance metric data collected from execution of the first data collection job 412-1 may be ingested into a first datastore 410-1 specified by user 414 in first configuration model 404-1. The performance metric data collected from execution of the second data collection job 412-2 may be ingested into a second datastore 410-2 specified by user 414 in second configuration model 404-2. Meanwhile, the performance metric data collected from execution of the third data collection job 412-N may be ingested into a third datastore 410-N specified by user 414 in third configuration model 404-N. The performance metric data may then be retrieved from its datastore and/or fed into observability platforms to provide performance metric analysis, comparison, monitoring, etc. In some instances, the performance metric data may be accessed and/or presented by a fleet manager service as described in greater detail with respect to FIG. 5.

The performance metric data being available in the common data format may facilitate comparison across jobs, across runtime environments, etc. For example, say that a user's website and using a first payment processing service for payment processing and then they switch payment processing services. With MDSA 402 this change can be submitted via a configuration model and serverless agent 406 can automatically change the scripts that are needed to perform that data collection job. Unlike existing synthetic monitoring agents, the performance metric data collected from the execution of the data collection job for both payment processing services will be in the same common data format. As such, user 414 does not need to change any of their monitoring utilities and may directly compare the performance metric data collected from synthetic monitoring operations of the two different payment processing services.

As previously described, the model specification configured by user 414 may be segmented (e.g., into a job configuration, a run configuration, a credential configuration, etc.). Without this segmentation, a change to a model specification will affect the whole flow. However, with this segmentation, serverless agent 406 is able to selectively change data collection jobs 412 based on whether configuration changes to portions of the model specification are relevant to their specific task.

For example, if a change is made to the job configuration portion of the model specification, then serverless agent 406 may need to make a corresponding change to the logic of all data collection jobs that are associated with performance of that job.

Alternatively, if a change is mage to the run configuration portion of the model specification, then serverless agent 406 may make the corresponding changes to only a subset of those data collection jobs (e.g., which may all be executing the same job just in different runtime environments) that are associated with and/or would be impacted by that particular change. As such, the serverless agent 406 is equipped to prosecute selective modification of data collection jobs 412.

FIG. 5 illustrates an example of a hybrid cloud environment 500 for managing model-driven agents for synthetic monitoring. Enterprises and financial institutions, among others, are frequently reluctant to host key services in public clouds due to security concerns. For example, key services associated with sensitive customer data may be restricted to being hosted only on that institution's premises and/or not allowed to be hosted in a public cloud. As a result, conducting synthetic monitoring operations on that institution's services may involve performing synthetic monitoring operations across multiple types (e.g., public, private, etc.) of environments.

MDSAs 506 (e.g., 506-1 . . . 506-N) and/or their collectors 508 (e.g., 508-1 . . . 508-N) may support on-premises 502 deployment (e.g., at a customer's own premises) in addition to SaaS deployment (e.g., in a third-party or public cloud). Supporting on-premises deployment may allow a user 512 to host a set of on-premises MDSAs and/or corresponding collectors on their own premises, within their private network when monitoring the endpoint services hosted on-premises 502. This can provide a user 512 with greater control and security over sensitive data and services.

In addition, the MDSAs 506 and/or their collectors 508 will support seamless integration of data collected from on-premises-based MDSA deployments with data collected from SaaS-based MDSA deployments. In this manner, performance metric data collected from execution of the set of on-premises-based MDSAs and/or from execution of the set of SaaS-based MDSAs that are collectively deployed for a common end-to-end user journey may be observed and visualized in a single plane of glass.

For example, the data from all the MDSAs 506 may be visualized in a single dashboard, allowing for comprehensive observability and analysis of the entire user journey from the user's interactions to the back-end systems, irrespective of where (e.g., which type of environment, geographic location, etc.) the services are hosted. This unified view may help a user 512 and/or an organization gain insights and make informed decisions to enhance the performance, reliability, and security of their services.

In various embodiments, one or more of the on-premises-based MDSA deployments may communicate with, cooperate with, and/or coordinate with one or more of SaaS-based MDSAs and/or their corresponding collector(s) to facilitate this integration. For instance, first MDSA 506-1, second MDSA 506-2, third MDSA 506-3, and fourth MDSA 506-4 may monitor (e.g., perform synthetic testing operations directed to) private endpoints hosted on-premises 502. The first MDSA 506-1 may ingest metrics to a first private collector 508-1 managed by user 512, second MDSA 506-2 may ingest metrics to a second private collector 508-2 managed by user 512, and/or third MDSA 506-3 may ingest metrics to a third private collector 508-3 managed by user 512. The fourth MDSA 506-4 may ingest metrics to a SaaS collector 508-N hosted in the SaaS 504 environment. The fifth MDSA collector 506-5, sixth MDSA collector 506-6, and seventh MDSA collector 506-N may monitor (e.g., perform synthetic testing operations directed to) public endpoints hosted in the SaaS 504 environment. The fifth MDSA collector 506-5, sixth MDSA collector 506-6, and seventh MDSA collector 506-N may ingest into SaaS collector 508-N hosted in the SaaS 504 environment.

Hybrid cloud environment 500 may include a fleet manager service 510 (e.g., 510-1 . . . 510-N). Fleet manager service 510 may be a utility that operates as a centralized MDSA fleet manager and/or visualizer. Fleet manager service 510 may manage data integration, configuration management, updates, deployment, scaling, monitoring, and/or data collection across MDSAs 506 regardless of where they are hosted. For example, fleet manager service 510 may manage the lifecycle of the MDSAs 506 deployed across multiple cloud regions, including both the agents hosted on-premises 502 and the agents hosted in SaaS 504 environment. Overall, the fleet manager service 510 may ensure efficient and consistent management of the MDSAs 506 deployed across different clouds and regions, centralize control, and provide users with a unified solution to monitor their applications and services, regardless of their deployment locations.

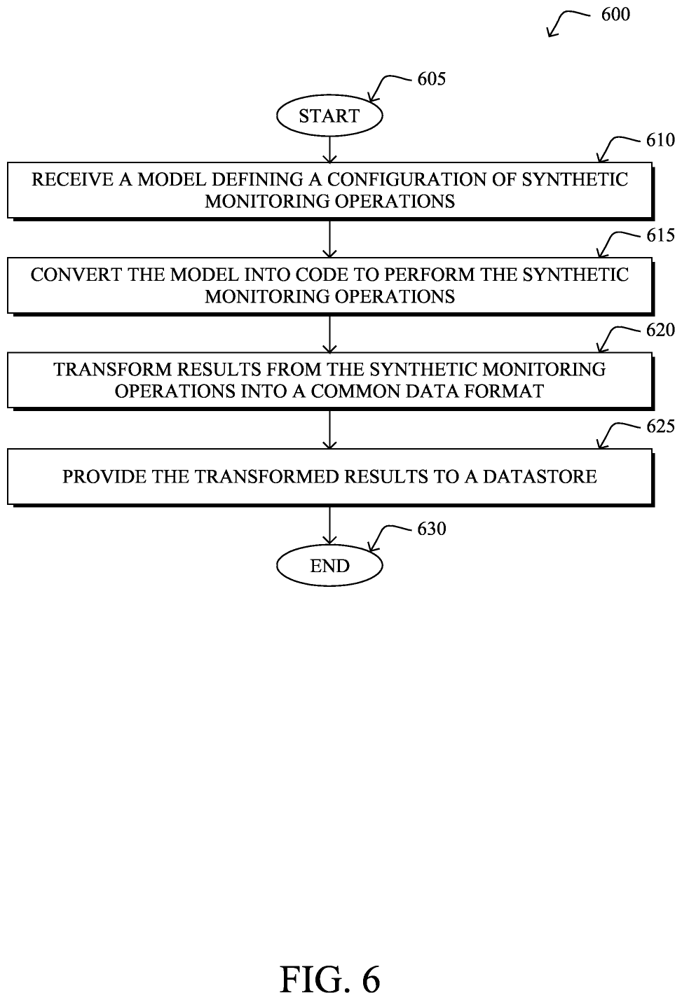

FIG. 6 illustrates an example simplified procedure for utilizing model driven agents for synthetic monitoring in accordance with one or more embodiments described herein. For example, a non-generic, specifically configured device (e.g., device 200) may perform procedure 600 by executing stored instructions (e.g., model driven agent process 248). Procedure 600 may start at step 605, and continues to step 610, where, as described in greater detail above, a model may be received defining a configuration of synthetic monitoring operations to be performed by a synthetic agent. The synthetic agent may be a serverless service.

The model defining the synthetic monitoring operations may include an indication of a programming language of the code into which the model is to be converted by the synthetic agent. The model defining the synthetic monitoring operations may define a job configuration defining a user journey as a script or a code snippet. In various embodiments, the model defining the synthetic monitoring operations identifies a private repository source where the job configuration is stored for retrieval by the synthetic agent.

The model defining the synthetic monitoring operations may define a runtime configuration for the synthetic monitoring operation. Additionally, the model defining the synthetic monitoring operations may define a credential configuration. The credential configuration may identify credentials for the synthetic monitoring operations as an encrypted value or as a location of a private secret vault where a credential is stored for retrieval by the synthetic agent.

At step 615, as detailed above, the model may be converted into code to be utilized by the synthetic agent to perform the synthetic monitoring operations. In various embodiments, a library of templates of pre-recorded synthetic monitoring operations in a plurality of scripting languages may be maintained. The model defining the configuration of synthetic monitoring operations may include a selection or customization of a template from the library of templates. This selected and/or customized template may be used by the synthetic agent in converting the model into the code to be utilized by the synthetic agent to perform the synthetic monitoring operations.

At step 620, results from performance of the synthetic monitoring operations may be transformed into transformed results in a common data format, as detailed above. The common data format may be an OpenTelemetry (OTEL) data format. The results from the performance of the synthetic monitoring operations may be performance metric data collected from an execution of a particular flow by the synthetic agent in testing a service. The model defining the synthetic monitoring operations may define parameters of collection logic to be incorporated into the code for collecting the performance metrics from the service.

At step 625, the transformed results may be provided to a datastore. The datastore may be a datastore and/or a datastore location specified by a user in the model. Additionally, result collection from the performance of the synthetic monitoring operations may be discontinued upon completion of the synthetic monitoring operations as specified in the model.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, facilitate proactively monitoring of user experience/performance and system availability with automated instrumentation of low-code synthetic agents that are highly scalable, polyglot, and zero-touch provisioned, all without incurring excessive engineering overheads and requiring manual intervention. Therefore, these techniques improve applications/websites/etc. performance, underlying computing device performance, underlying computing network performance, and/or attack surface identification and mitigation.

While there have been shown and described illustrative embodiments that provide model driven agents for synthetic monitoring, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of scripting languages and common data formats are discussed herein, the techniques herein may be used in conjunction with any scripting language or common data format.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, by a device, a model defining a configuration of synthetic monitoring operations to be performed by a synthetic agent;
converting, by the device, the model into code to be utilized by the synthetic agent to perform the synthetic monitoring operations;
transforming, by the device, results from a performance of the synthetic monitoring operations into transformed results in a common data format; and
providing, by the device, the transformed results to a datastore.

2. The method as in claim 1, wherein the synthetic agent is a serverless service.

3. The method as in claim 1, wherein results from the performance of the synthetic monitoring operations are performance metric data collected from an execution of a particular flow by the synthetic agent in testing a service and wherein the model defining the synthetic monitoring operations defines parameters of collection logic to be incorporated into the code for collecting the performance metric data from the service.

4. The method as in claim 1, wherein the model defining the synthetic monitoring operations includes an indication of a programming language of the code into which the model is to be converted by the synthetic agent.

5. The method as in claim 1, wherein the model defining the synthetic monitoring operations defines a job configuration defining a user journey as a script or a code snippet.

6. The method as in claim 5, wherein the model defining the synthetic monitoring operations identifies a private repository source where the job configuration is stored for retrieval by the synthetic agent.

7. The method as in claim 1, wherein the model defining the synthetic monitoring operations defines a runtime configuration for the synthetic monitoring operations.

8. The method as in claim 1, wherein the model defining the synthetic monitoring operations defines a credential configuration identifying credentials for the synthetic monitoring operations as an encrypted value or as a location of a private secret vault where a credential is stored for retrieval by the synthetic agent.

9. The method as in claim 1, further comprising:
maintaining a library of templates of pre-recorded synthetic monitoring operations in a plurality of scripting languages.

10. The method as in claim 9, wherein the model defining the configuration of synthetic monitoring operations includes a selection or customization of a template from the library of templates to be used by the synthetic agent in converting the model into the code to be utilized by the synthetic agent to perform the synthetic monitoring operations.

11. The method as in claim 1, wherein the common data format is an Open Telemetry (OTEL) data format.

12. The method as in claim 11, further comprising:
discontinuing result collection from the performance of the synthetic monitoring operations upon completion of the synthetic monitoring operations as specified in the model.

13. A tangible, non-transitory, computer-readable medium having computer-executable instructions stored thereon that, when executed by a processor on a computer, cause the computer to perform a method comprising:
receiving a model defining a configuration of synthetic monitoring operations to be performed by a synthetic agent;
converting the model into code to be utilized by the synthetic agent to perform the synthetic monitoring operations;
transforming results from performance of the synthetic monitoring operations into a common data format; and
providing the results from the synthetic agent in the common data format to a datastore.

14. The method as in claim 13, wherein the model defining the synthetic monitoring operations includes an indication of a programming language of the code into which the model is to be converted by the synthetic agent.

15. The method as in claim 13, wherein the model defining the synthetic monitoring operations defines a job configuration defining a user journey as a script or a code snippet.

16. The method as in claim 13, wherein the model defining the synthetic monitoring operations defines a runtime configuration for the synthetic monitoring operations including an indication of the common data format and the datastore.

17. The method as in claim 13, wherein the model defining the synthetic monitoring operations defines a credential configuration identifying credentials for the synthetic monitoring operations as an encrypted value or as a location of a private secret vault where a credential is stored for retrieval by the synthetic agent.

18. The method as in claim 13, wherein the model defining the configuration of synthetic monitoring operations includes a selection or customization of a template, from a library of templates of pre-recorded synthetic monitoring operations in a plurality of scripting languages, to be utilized by the synthetic agent in converting the model into the code to perform the synthetic monitoring operations.

19. The method as in claim 13, wherein results from the performance of the synthetic monitoring operations are performance metric data collected from an execution of a particular flow by the synthetic agent in testing a service and wherein the model defining the synthetic monitoring operations defines parameters of collection logic to be incorporated into the code for collecting the performance metric data from the service.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
receive a model defining a configuration of synthetic monitoring operations to be performed by a synthetic agent;
convert the model into code to be utilized by the synthetic agent to perform the synthetic monitoring operations;
transform results from a performance of the synthetic monitoring operations into transformed results in a common data format; and
provide the transformed results to a datastore.
